(19) United States
(12) Patent Application Publication
(10) Pub. No.: US 2018/0018581 A1
(43) Pub. Date: Jan. 18, 2018

(54) SYSTEM AND METHOD FOR MEASURING AND ASSIGNING SENTIMENT TO ELECTRONICALLY TRANSMITTED MESSAGES

(71) Applicant: Andrew Geoffrey Cook, Weltevreden Park (ZA)

(72) Inventor: Andrew Geoffrey Cook, Weltevreden Park (ZA)

(21) Appl. No.: 15/238,689

(22) Filed: Aug. 16, 2016

Related U.S. Application Data
(60) Provisional application No. 62/363,194, filed on Jul. 15, 2016.

(51) Int. Cl. G06N 99/00; G06F 17/28; H04L 29/08; H04L 29/06

(52) U.S. Cl. CPC G06N 99/005; H04L 67/42; G06F 17/28; H04L 67/10

(57) ABSTRACT

A system for measuring and assigning sentiment using a sentiment analysis measurement module to intercept, collect, evaluate, and assign sentiment ratings to electronically transmitted messages, and deliver said messages with associated indicia of sentiment, be they visual or audible, either within a message delivery framework or as an after-market addition to a messaging system, for the benefit of a recipient.

### CROSS-REFERENCE TO RELATED APPLICATIONS

The present application claims the benefit of, and priority to, U.S. provisional patent application Ser. No. 62/363,194, titled “SYSTEM AND METHOD FOR MEASURING AND ASSIGNING SENTIMENT TO ELECTRONICALLY TRANSMITTED MESSAGES” and filed on Jul. 15, 2016, the entire specification of which is incorporated herein by reference in its entirety.

### BACKGROUND OF THE INVENTION

### Field of the Art

The disclosure relates to the field of subjectivity analysis, and more particularly to the field of opinion mining, in which text analysis, computational linguistics, machine learning, artificial intelligence, and natural language processing may be used to identify sentiment of electronically transmitted messages.

### Discussion of the State of the Art

Opinion mining, also known as sentiment analysis, pertains to utilizing text analysis, computational linguistics, machine learning, artificial intelligence, and natural language processing to identify and extract information in source materials.

Typically, sentiment analysis aims to determine an attitude or emotion associated with a given communication with respect to some topic and overall contextual sentiment or polarity. The attitude may be an evaluation based on a specific data-set of terms and associated sentiments, or it may be an affective state which is initiated by the author, or still, it may be the intended emotional communication intended to be imposed upon recipient of the communication.

Sentiment analysis is widely applied to reviews and social media for a variety of applications, ranging from marketing to customer service. Reviews and opinions are formulated on varying features or aspects of entities, such as consumer goods or services, with the prime purpose being to identify relational quality, even if it is subjective by nature, to prospective consumers, prospective suppliers, existing suppliers, and other parties of interest. Businesses may look to sentiment analysis results as they intend to market products, identify new opportunities, and manage their existing assets. However, results are targeted to provide information to a specific group within the business, or in other cases, to the public, or more specifically, the users of the platforms on which said reviews are produced and published. The subject of the analysis is limited to an offered item or service. In other cases, it is limited to a public sentiment or view of a political movement or current-event made available to the general public, typically via the media.

What is needed in the art is a way to assign and identify sentiment to a recipient of an electronically transmitted message, either separate from the message delivery system or within the message delivery system, such that the recipient may decide how and when to process the message. Further, what is needed in the art is a way to measure, assign and identify sentiment of a message to a delivery system that presents messages to recipients. Also, what is needed in the art is a way to sort, prioritize and manage sentiment of messages within their respective delivery methods and modes of communication. Further needed in the art is a way to measure and assign sentiment as indicia of sentiment which can be identified and presented at the time of delivery of the electronic message or embedded within the electronic message.

### SUMMARY OF THE INVENTION

Accordingly, the inventor has conceived and reduced to practice, in a preferred embodiment of the invention, a system for measuring and assigning sentiment to an electronically transmitted message, comprising: a sentiment analysis measurement module comprising at least a plurality of programming instructions stored in a memory and operating on a processor of a network-connected computing device and configured to utilize a message collector component as an interface between an incoming messaging service and a recipient device through which an 0065lectronic message will be received; evaluate the incoming electronic message against a prescribed data set contained within a sentiment analysis database; communicate with a sentiment analysis tool which executes an extensive set of algorithms to parse, classify and analyze the message such that indicia of sentiment may be assigned; task a message rating component to assign the indicia of sentiment to the message; and utilize a sentiment indicator management tool to apply a plurality of rules to sort, assign priority, or toggle options for a preferred mode of identification for the indicia of sentiment.

According to another preferred embodiment of the invention, a system for measuring and assigning sentiment to an electronically transmitted message, comprising: a sentiment analysis measurement module comprising at least a plurality of programming instructions stored in a memory and operating on a processor of a network-connected computing device and further comprising a messaging relay component, configured to assign indicia of sentiment which may be identified and presented at the time of delivery of the electronic message or embedded within the electronic message, is disclosed.

According to another preferred embodiment of the invention, a method for measuring and assigning sentiment to an electronically transmitted message by using a sentiment analysis measurement module, the method comprising the steps of: receiving and collecting electronic messages, either directly or as an appended add-on to another messaging service via a message collector component module; utilizing the message collector component as an interface between an incoming messaging service and a recipient device through which an electronic message will be received; evaluating the incoming electronic message against a prescribed data set contained within a sentiment analysis database; communicating with a sentiment analysis tool which executes an extensive set of algorithms to parse, classify and analyze the message such that indicia of sentiment may be assigned; tasking a message rating component to assign the indicia of sentiment to the message; and utilizing a sentiment indicator management tool to apply a plurality of rules to sort, assign priority, or toggle options for a preferred mode of identification for the indicia of sentiment.

According to another preferred embodiment of the invention, a method for assigning and displaying sentiment for an electronically transmitted message by using a sentiment analysis measurement module, the method comprising the steps of: receiving and collecting electronic messages, either directly or as an appended add-on to another messaging service via a message collector component; utilizing the message collector component as an interface between an messaging delivery service and a recipient device through which an electronic message will be received; tasking a message relay component to dispatch the electronic message to a preferred third party sentiment analysis tool which will evaluate and assign a sentiment rating; tasking a message rating component to assign indicia of sentiment to the message based on the sentiment rating received; and utilizing a sentiment indicator management tool to apply a plurality of rules to sort, assign priority, or toggle options for a preferred mode of identification for the indicia of sentiment, is disclosed.

According to another preferred embodiment of the invention, a method for assigning and displaying sentiment for an electronically transmitted message by using a sentiment analysis measurement module, the method comprising the steps of: utilizing a message collector component as an interface between a recipient device through which an electronic message has been received and the sentiment analysis measurement module located on the recipient device; collecting electronic messages, either directly or as an appended add-on to another messaging service via a message collector component; evaluating the received electronic message against a prescribed data set contained within a sentiment analysis library; communicating with a sentiment analysis tool which executes an extensive set of algorithms to parse, classify and analyze the message such that indicia of sentiment is assigned; tasking a message rating component to assign the indicia of sentiment to the message; and utilizing a sentiment indicator management tool to apply a plurality of rules to sort, assign priority, or toggle options for a preferred mode of identification for the indicia of sentiment, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary system architecture for a sentiment analysis measurement module that uses a web server, an application server, a message collector component, a sentiment analysis tool, a sentiment analysis database, a message rating component, and a sentiment indicator management tool, according to a preferred embodiment of the invention.

FIG. 2 is a block diagram illustrating an exemplary system architecture for a sentiment analysis measurement module that uses a messaging network to manage a web server, an application server, a message collector component, a sentiment analysis tool, a sentiment analysis database, a message rating component, a sentiment indicator management tool, and a message relay component, according to another preferred embodiment of the invention.

FIG. 3 is a block diagram illustrating an exemplary system architecture for a sentiment analysis measurement module that uses a web server, an application server, a message collector component, a message relay component, and a sentiment indicator management tool to manage and operate the sentiment analysis measurement module, according to another preferred embodiment of the invention.

FIG. 4 is a flow diagram illustrating an exemplary method for using a sentiment analysis measurement module within an electronic message delivery framework, according to a preferred embodiment of the invention.

FIG. 5 is a flow diagram illustrating an exemplary method for measuring and assigning sentiment to an electronically transmitted message by using a sentiment analysis measurement module, including a sentiment analysis tool, according to a preferred embodiment of the invention.

FIG. 6 is a flow diagram illustrating another exemplary method for assigning and displaying sentiment for an electronically transmitted message by using a sentiment analysis measurement module without the use of a sentiment analysis tool, according to another preferred embodiment of the invention.

FIG. 7 is a conceptual illustration containing FIG. 7A and FIG. 7B, with each modeling an exemplary indicia of sentiment analysis measurement module depicting indicia of sentiment displayed within a messaging system.

FIG. 8 is another conceptual illustration containing FIG. 8A and FIG. 8B, with each modeling an exemplary indicia of sentiment analysis measurement module depicting indicia of sentiment displayed within a messaging system.

FIG. 9 is a block diagram illustrating another exemplary system architecture for a sentiment analysis measurement module that uses a web server, an application server, a message collector component, a sentiment analysis tool, a sentiment analysis library, a message rating component, and a sentiment indicator management tool, all of which are located on a device, according to a preferred embodiment of the invention.

FIG. 10 is a block diagram illustrating another exemplary system architecture for a sentiment analysis measurement module that uses a message collector component, a sentiment analysis tool, a sentiment analysis library, a message rating component, and a sentiment indicator management tool, all of which are located on a device, according to a preferred embodiment of the invention.

FIG. 11 is a flow diagram illustrating another exemplary method for using a sentiment analysis measurement module on a device, according to a preferred embodiment of the invention.

FIG. 12 is a flow diagram illustrating an exemplary method for measuring and assigning sentiment to an electronically transmitted message by using a sentiment analysis measurement module, including a sentiment analysis tool, according to a preferred embodiment of the invention.

FIG. 13 is a block diagram illustrating an exemplary hardware architecture of a computing device used in an embodiment of the invention.

FIG. 14 is a block diagram illustrating an exemplary logical architecture for a client device, according to an embodiment of the invention.

FIG. 15 is a block diagram showing an exemplary architectural arrangement of clients, servers, and external services, according to an embodiment of the invention.

FIG. 16 is another block diagram illustrating an exemplary hardware architecture of a computing device used in various embodiments of the invention.

### DETAILED DESCRIPTION

The inventor has conceived, and reduced to practice, in a preferred embodiment of the invention, a system and method for measuring and assigning sentiment to an electronically transmitted message using a sentiment analysis measurement module.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

Definitions

As used herein, “message” refers to an electronic communication, in written, audible, or pictorial form (for example, SMS, email, blogs, tweets, reviews, voicemail, etc.). A message is an electronic communication in speech, writing, images or signals, and often one left for a recipient who cannot be directly contacted.

Conceptual Architecture

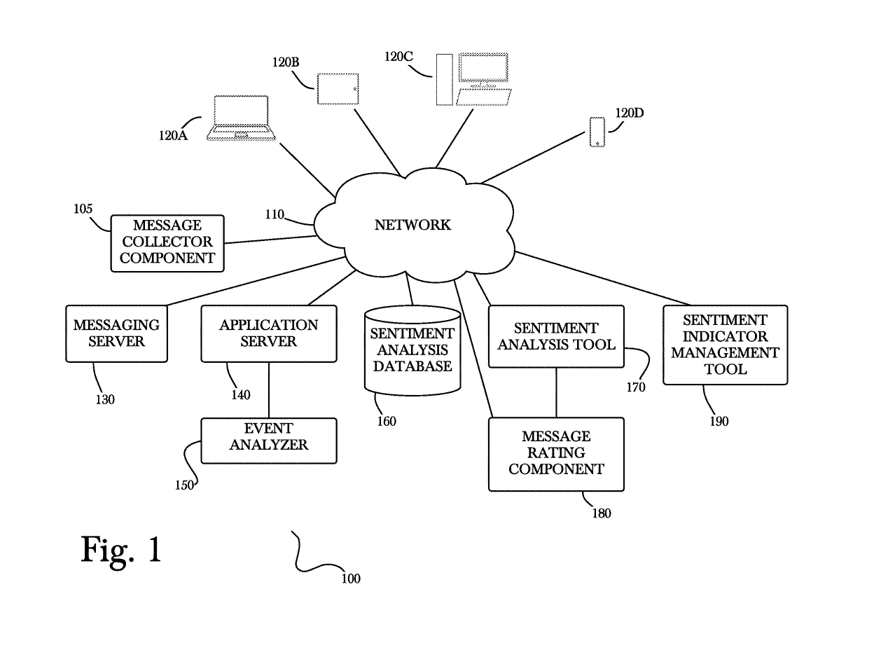

FIG. 1 is a block diagram of an exemplary system architecture 100 for a sentiment analysis measurement module, according to a preferred embodiment of the invention. According to the embodiment, a message collector component 105, a sentiment analysis database 160, a sentiment analysis tool 170, a message rating component 180, and a sentiment indicator management tool 190 may be stored and be operable on a computing device, for example a laptop 120A, tablet 120B, work station 120C, smartphone 120D, or similar such device enabled to communicate via a network 110 with system 100, the system comprising a messaging collector component 105, a messaging server 130, an application server 140, and an event analyzer 150. The messaging server 130 may work in parallel with the application server 140, to process messaging requests from a message delivery framework, located on a computing device 120A/B/C/D, while the application server 140, utilizing an event analyzer 150 to evaluate requests, communicates with the messaging server 130, sentiment analysis database 160, the sentiment analysis tool 170, the message rating component 180, and the sentiment indicator management tool 190, to carry out application specific code in response to message transmission and delivery commands, and in accordance with actions deemed necessary by the message collector component 105. For each device 120A/B/C/D attempting to transmit electronic text through the messaging server 130, the message collector component 105 acts to intercept, process, and redirect through to the sentiment analysis tool 170 and the message rating component 180. By way of example, system 100 may be applied to an instant messaging framework wherein sentiment is assigned to a specific string of text within an instant message. The message collector component 105 acts to collect and redirect the text message through system 100, eventually back to originally intended receiving device, which may be any of devices 120A/B/C/D through the intended message delivery framework, generally labeled as the messaging server 130. The sentiment indicator management tool 190 may be accessed and optimized for any of devices 120A/B/C/D to specifically manage settings for system 100 on each respective device.

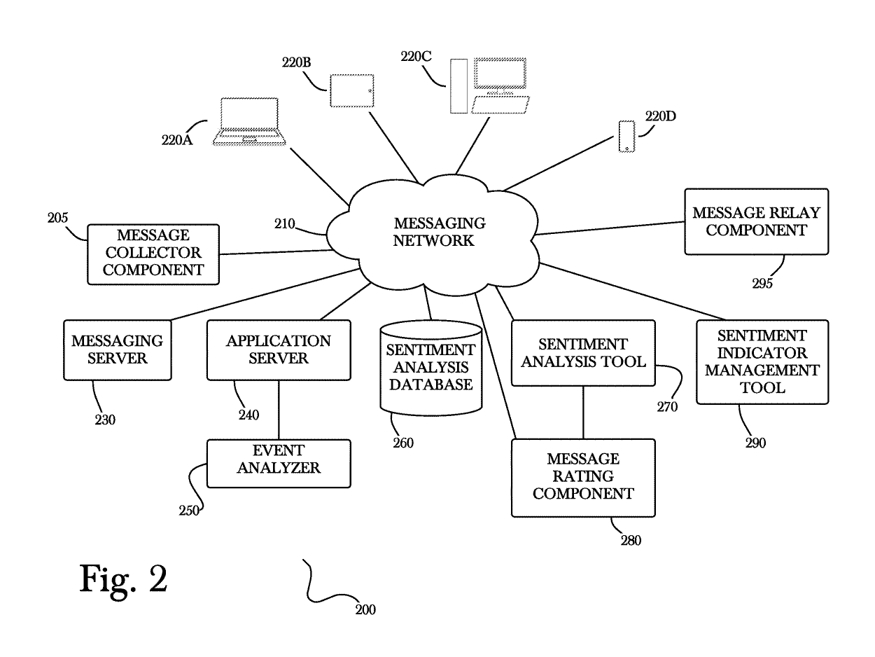

FIG. 2 is a block diagram of an exemplary system architecture 200 for a sentiment analysis measurement module, according to another preferred embodiment of the invention. According to the embodiment, a message collector component 205, a sentiment analysis database 260, a sentiment analysis tool 270, a message rating component 280, and a sentiment indicator management tool 290 may be stored and be operable on a computing device, for example a laptop 220A, tablet 220B, work station 220C, smartphone 220D, or similar such device enabled to communicate via a messaging network 210 with system 200, the system comprising a messaging collector component 205, a messaging server 230, an application server 240, and an event analyzer 250. The messaging server 230 may work in parallel with the application server 240, to process messaging requests from a message delivery framework, located on a computing device 220A/B/C/D, while the application server 240, utilizing an event analyzer 250 to evaluate requests, communicates with the messaging server 230, sentiment analysis database 260, the sentiment analysis tool 270, the message rating component 280, and the sentiment indicator management tool 290, to carry out application specific code in response to message transmission and delivery commands, and in accordance with actions deemed necessary by the message collector component 205. For each device 220A/B/C/D attempting to transmit electronic text through the messaging server 230, the message collector component 205 acts to intercept, process, and redirect through to the sentiment analysis tool 270 and the message rating component 280. The sentiment indicator management tool 290 may be accessed and optimized for any of devices 220A/B/C/D to specifically manage settings for system 200 on each respective device. Similar to system 100, system 200 includes a message relay component 295 to work in tandem with message collector component 205 to outsource sentiment analysis computation and analysis to an external system, external to system 200. The message relay component 295 works as an automated message or mail transfer agent, to dispatch a text message, either as an instant message or as an electronic mail transmission, and receive a corresponding evaluated message back with an associated sentiment rating either attached or otherwise embedded within the text transmission.

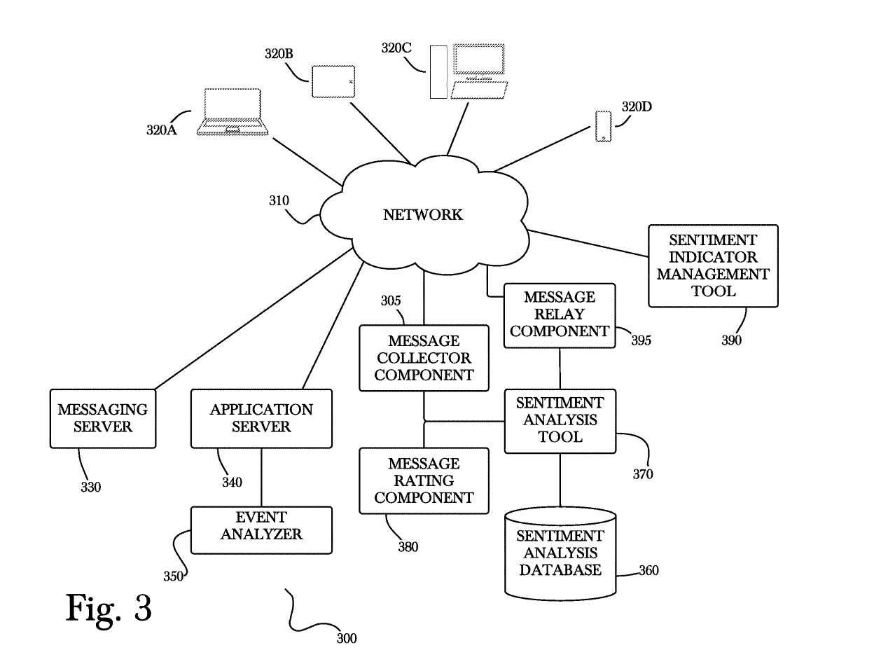

FIG. 3 is a block diagram of an exemplary system architecture 300 for a sentiment analysis measurement module, according to another preferred embodiment of the invention. According to the embodiment, a message collector component 305, a sentiment analysis database 360, a sentiment analysis tool 370, a message rating component 380, and a sentiment indicator management tool 390 may be stored and be operable on a computing device, for example a laptop 320A, tablet 320B, work station 320C, smartphone 320D, or similar such device enabled to communicate via a messaging network 310 with system 300, the system comprising a messaging collector component 305, a messaging server 330, an application server 340, and an event analyzer 350. The messaging server 330 may work in parallel with the application server 340, to process messaging requests from a message delivery framework, located on a computing device 320A/B/C/D, while the application server 340, utilizing an event analyzer 350 to evaluate requests, communicates with the messaging server 330, sentiment analysis database 360, the sentiment analysis tool 370, the message rating component 380, and the sentiment indicator management tool 390, to carry out application specific code in response to message transmission and delivery commands, and in accordance with actions deemed necessary by the message collector component 305. For each device 320A/B/C/D attempting to transmit electronic text through the messaging server 330, the message collector component 205 acts to intercept, process, and redirect through to the sentiment analysis tool 370 and the message rating component 380. The sentiment indicator management tool 390 may be accessed and optimized for any of devices 320A/B/C/D to specifically manage settings for system 300 on each respective device. With components similar to system 200, arrangement of system 300 provides access to network 310 via either the message collector component 305 or the message relay component 395. Message rating component 380, sentiment analysis tool 370 and sentiment analysis database 360 may require additional permission to access, hence such protocols may be administered via the message collector component 305 and the message relay component 395.

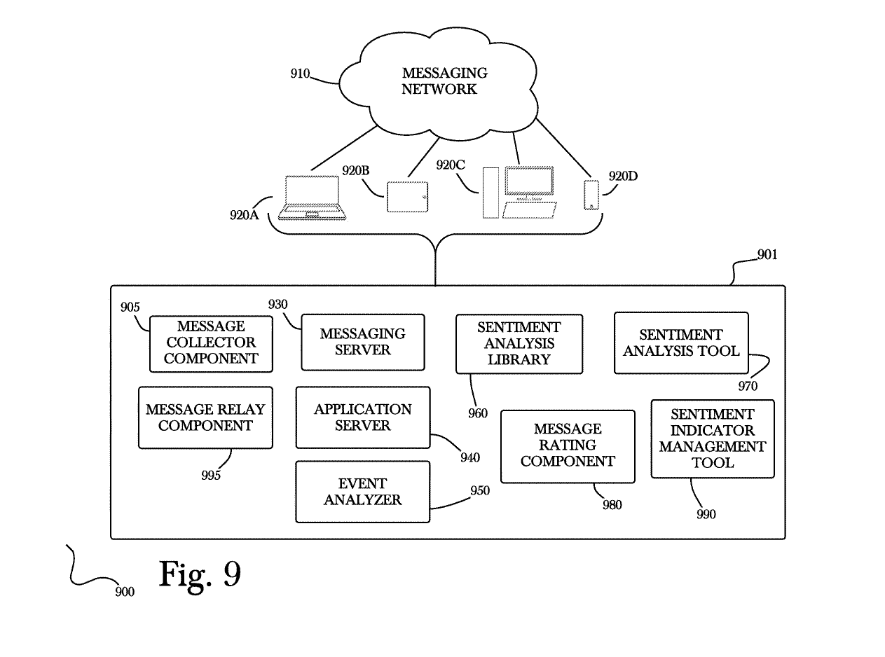

FIG. 9 is a block diagram of an exemplary system architecture 900 for a sentiment analysis measurement module 901, according to another preferred embodiment of the invention. According to the embodiment, the sentiment analysis measurement module 901, comprising a message collector component 905, a message server 930, an application server 940, an event analyzer 950, a sentiment analysis library 960, a sentiment analysis tool 970, a message rating component 980, and a sentiment indicator management tool 990, may be stored and be operable on a computing device, for example a laptop 920A, tablet 920B, work station 920C, smartphone 920D, or similar such device enabled to communicate via a messaging network 910. In this configuration, sentiment analysis measurement module 901 need not be connected to a messaging network in order to carry out its function of measuring and assigning sentiment to a target message. The messaging server 930 may work in parallel with the application server 940, to process messaging requests from a message delivery framework, located on a computing device 920A/B/C/D, while the application server 940, utilizing an event analyzer 950 to evaluate requests, communicates with the messaging server 930, sentiment analysis library 960, the sentiment analysis tool 970, the message rating component 980, and the sentiment indicator management tool 990, to carry out application specific code in response to message transmission and delivery commands, and in accordance with actions deemed necessary by the message collector component 905. For each device 920A/B/C/D attempting to transmit electronic text through the messaging server 930, the message collector component 905 acts to process and redirect through to the sentiment analysis tool 970 and the message rating component 980. The sentiment indicator management tool 990 may be accessed and optimized for any of devices 920A/B/C/D to specifically manage settings for system 900 on each respective device. System 900 includes a message relay component 995 to work in tandem with message collector component 905 to identify, collect, and process messages through the sentiment analysis measurement module 901. The message relay component 995 works as an automated message or mail transfer agent, to dispatch a text message, either as an instant message or as an electronic mail transmission with an associated sentiment rating either attached or otherwise embedded within the message back to the corresponding device 920A/B/C/D.

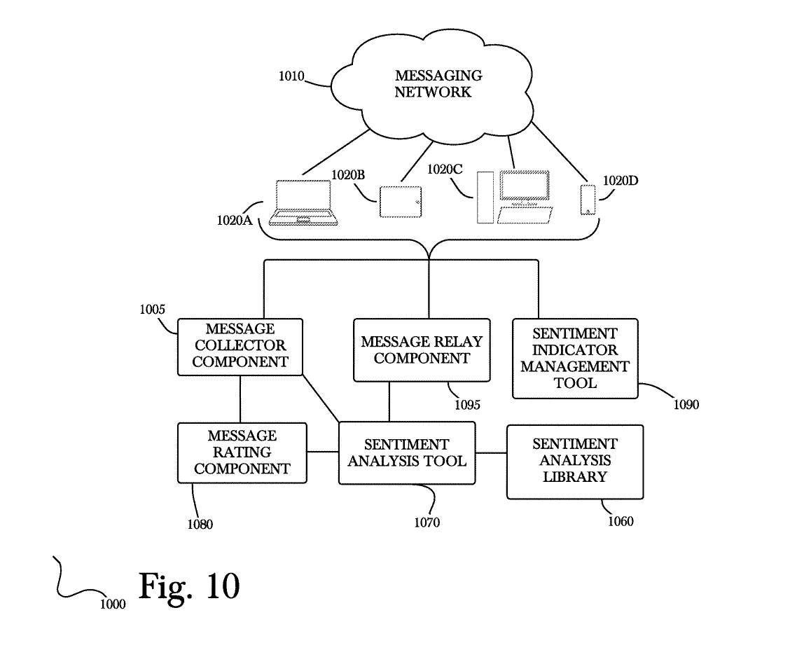

FIG. 10 is a block diagram of an exemplary system architecture 1000 for a sentiment analysis measurement module, according to another preferred embodiment of the invention According to the embodiment, a message collector component 1005, a sentiment analysis library 1060, a sentiment analysis tool 1070, a message rating component 1080, and a sentiment indicator management tool 1090 may be stored and be operable on a computing device, for example a laptop 1020A, tablet 1020B, work station 1020C, smartphone 1020D, or similar such device enabled to communicate via a messaging network 1010. For each device 1020A/B/C/D in receipt of a message via message network 1010, message collector component 1005 acts to process and redirect through to the sentiment analysis tool 1070, connected to the sentiment analysis library 1090 and the message rating component 1080, before directing back through the sentiment analysis tool 1070 to return a sentiment rated message back to respective recipient device 1020A/B/C/D via the message replay component, 1095. The sentiment indicator management tool 1090 may be accessed and optimized for any of devices 1020A/B/C/D to specifically manage settings for system 1000 on each respective device.

It should be appreciated that according to the embodiment, various means of connection or communication between the components of system 100/200/300/900/1000 may be utilized according to the invention interchangeably or simultaneously, such as for example a direct, physical data connection (such as via a data cable or similar physical means), a software-based connection such as via an application programming interface (API) or other software communication means (such as may be suitable, for example, in arrangements where multiple system components may operate on a single hardware device such as a computing server or workstation), or any of a variety of network connections such as via the Internet or other data communications network. It should therefore be appreciated that the connections shown are exemplary in nature and represent only a selection of possible arrangements, and that alternate or additional connections may be utilized according to the invention.

Detailed Description of Exemplary Embodiments

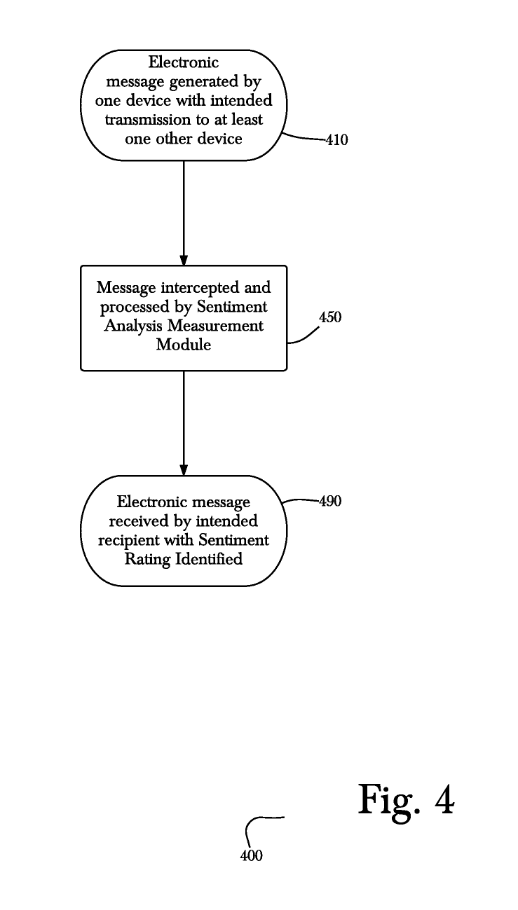

FIG. 4 is a flow diagram illustrating an exemplary method 400 for intercepting a message transmission to process and assign a sentiment rating by using a sentiment analysis measurement module, according to a preferred embodiment of the invention. Simplistically, whether the mode of electronic message transmission is via SMTP for electronic mail or similar such protocol or derivative, such as LMTP, or in case of instant messaging (IM) by way of chat or text messaging via a client-server architecture, an electronic message, be it email, IM, SMS, or other similar such message containing characters, is ultimately generated by one device with an intended transmission and delivery to at least one other device 410. This first step may comprise several intermediate steps within which may be specific to the mode of delivery, transmission framework, and type of transmission. Within method step 410, other sub-steps may occur, however irrelevant as a message need only be transmitted in a known and designed way, such that system 100/200/300 as preferred embodiments of the invention may intercept, process, and redirect 450 it to its original destination with a sentiment rating attached to or embedded within the message 490. The sentiment analysis measurement module 100/200/300 may be configured to receive and push messages, or intercept and relay messages, or even intercept and deliver messages or any combination necessary to communicate with a targeted mode of transmission, such that sentiment may be evaluated and assigned as intended.

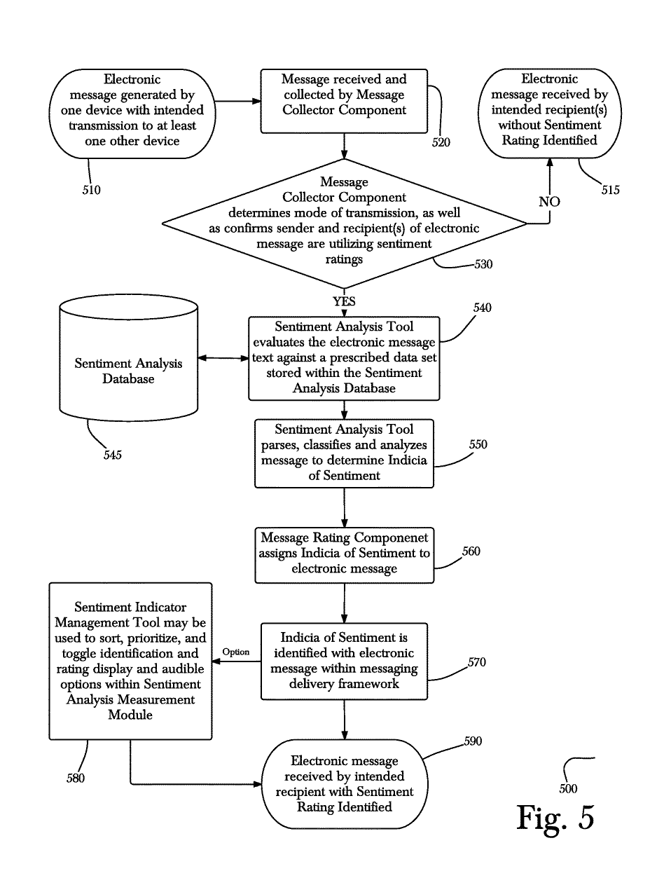

FIG. 5 is a flow diagram illustrating an exemplary method 500 for measuring and assigning sentiment to an electronically transmitted message by using a sentiment analysis measurement module 100/200/300, according to a preferred embodiment of the invention. As depicted in FIG. 4, an electronic message having been generated by one device with an intended transmission to at least one other device 510 is received and collected by a message collector component 520, which determines which mode of transmission is intended, and the intended recipient(s), then confirms all parties are utilizing sentiment ratings 530 before pushing the message to the sentiment analysis tool 170/270/370. In a case where a recipient device is not using sentiment ratings, a sentiment indicator management tool may be engaged from a transmitting device to prompt a recipient device to allow use of sentiment ratings with corresponding messages. If the use of sentiment ratings is not allowed, the original message may be redirected to an original intended recipient(s) 515 without a sentiment rating identified. If at least one recipient device has sentiment ratings enabled, a sentiment analysis tool evaluates the electronic message text against a prescribed data set 540 stored in a sentiment analysis database 545 of key words and phrases, seeking matches and probable matches considering context, inflection, syntax, and grammar of the message being evaluated. The sentiment analysis tool executes an extensive set of algorithms in order to parse, classify and analyze 550 the message to determine indicia of sentiment, which may be depicted as an integer, being positive representing a positive indicator, being close to zero representing a neutral indicator, and being negative representing a negative indicator. Indicia of sentiment is not necessarily visible within the sentimental rating of a message, but is necessary to identify a selected mode of indication that remains constant and stable in comparison to other rating actions performed. For example, this may equate to a negative integer being represented by a negative identifier, such as a red hue, an angry digitized face, or an image of a thumbs down. Indicia of sentiment, visible or not, is the basic premise for equating sentiment to the message, and the rating scale for sentiment is a function of the indicia of sentiment. A message rating component checks the preferred settings of the recipient device and accordingly assigns the indicia of sentiment to the electronic message 560 in the desired and programmed format. Indicia of sentiment is identified by the sentiment analysis tool 170/270/370 and then assigned by a message rating component 180/280/380. The indicia of sentiment may be identified with the electronic message within the messaging delivery framework 570 before being pushed to the original intended recipient with a sentiment rating identified 590. For example, one device may opt for a red color to identify a negatively rated message, whilst a different device may opt for a red color to identify a positively rated message. Whilst indicia of sentiment may be assigned preferentially by use of the sentiment indicator management tool 190/290/390, the output from the sentiment analysis tool 170/270/370 remains stable to a known scale and associated equation, thus the input from the sentiment analysis tool 170/270/370 to the message rating component 180/280/380 is also stable and constant, whilst the output of the message rating component 180/280/380 may be altered and displayed preferentially, as per settings managed from within the sentiment indicator management tool 190/290/390. The sentiment indicator management tool may be used to sort, prioritize, and toggle identification ratings and audible options within the sentiment analysis measurement module 580, such that a receiving device receives represented indicia of sentiment according to desired preferences, as in the case above, a red hued message to depict positive sentiment in one scenario, or negative sentiment in the other. It is also entirely possible that a red-colored hue could be set to depict a neutral rating, should such a setting be desired to be illustrated on a recipient's device. The choice of color is merely exemplary, and sentiment rating identification is not limited. Sentiment ratings may be attached to the message, displayed in an adjacent field within the message summary page within the delivery framework, or may be embedded within the message itself, forming associative properties with the message. Indicia may be depicted as numbers, integers, colors, visual images or audibly. Furthermore, visual images as indicators may be depicted as artistic renditions of facial expressions, cartoon replications of flora, fauna, natural elements, or virtually any recognizable representation of emotion or sentiment known to the art. Options to upload preferred images or audio files may be managed within the sentiment indicator management tool, and may be shared or kept specific for use on a specified device or set of devices.

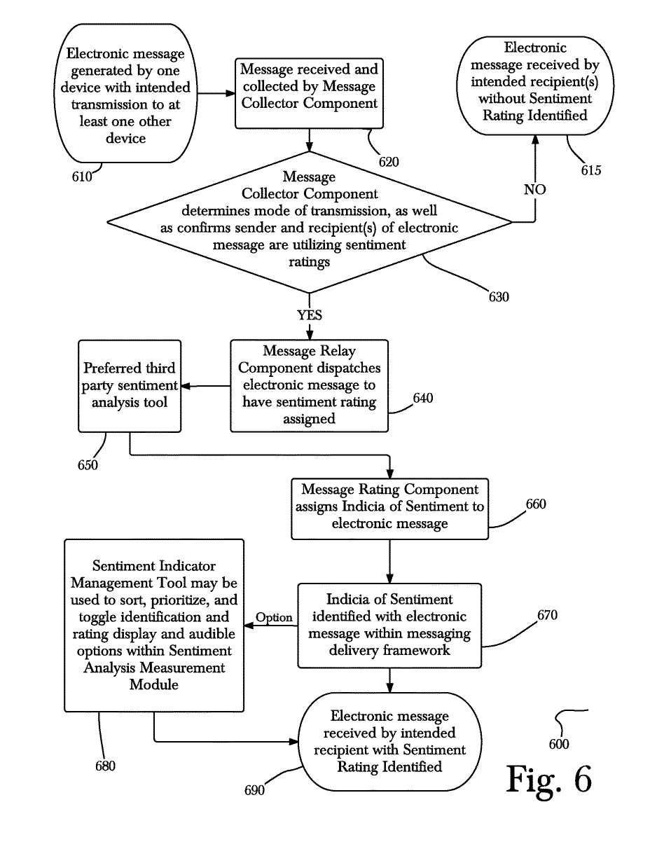

FIG. 6 is a flow diagram illustrating an exemplary method 600 for assigning and displaying sentiment for an electronically transmitted message by using a sentiment analysis measurement module, according to another preferred embodiment of the invention. Similar to method 500 as depicted on FIG. 5, method 600 allows for sentiment analysis to be performed external 650 to the sentiment analysis measurement module 100/200, and for input from a preferred third party analysis tool 650 to be utilized in lieu of output generated from an internal sentiment analysis tool 550. As simplistically depicted in FIG. 4, FIG. 6 elaborates on FIG. 4 with method 600 for an electronic message having been generated by one device with an intended transmission to at least one other device 610 is received and collected by a message collector component 620, which determines which mode of transmission is intended, and the intended recipient(s), then confirms all parties are utilizing sentiment ratings 630 before pushing the message to the sentiment analysis tool 170/270. In a case where a recipient device is not using sentiment ratings, a sentiment indicator management tool may be engaged from a transmitting device to prompt a recipient device to allow use of sentiment ratings with corresponding messages. If the use of sentiment ratings is not allowed, the original message may be redirected to an original intended recipient(s) 615 without a sentiment rating identified. If at least one recipient device has sentiment ratings enabled, a message replay component dispatches the electronic message to have a sentiment rating assigned 640 by a preferred third party sentiment analysis tool 650. And similarly to method 500, method 600 follows suit as a message rating component assigns indicia of sentiment to the electronic message 660 based on the input received from the preferred third party sentiment analysis tool 650. The indicia of sentiment may be identified with the electronic message within the messaging delivery framework 670 before being pushed to the original intended recipient with a sentiment rating identified 690. The sentiment management tool may be used to sort, prioritize, and toggle identification ratings and audible options within the sentiment analysis measurement module 680, such that a receiving device receives represented sentiment according to desired preferences.

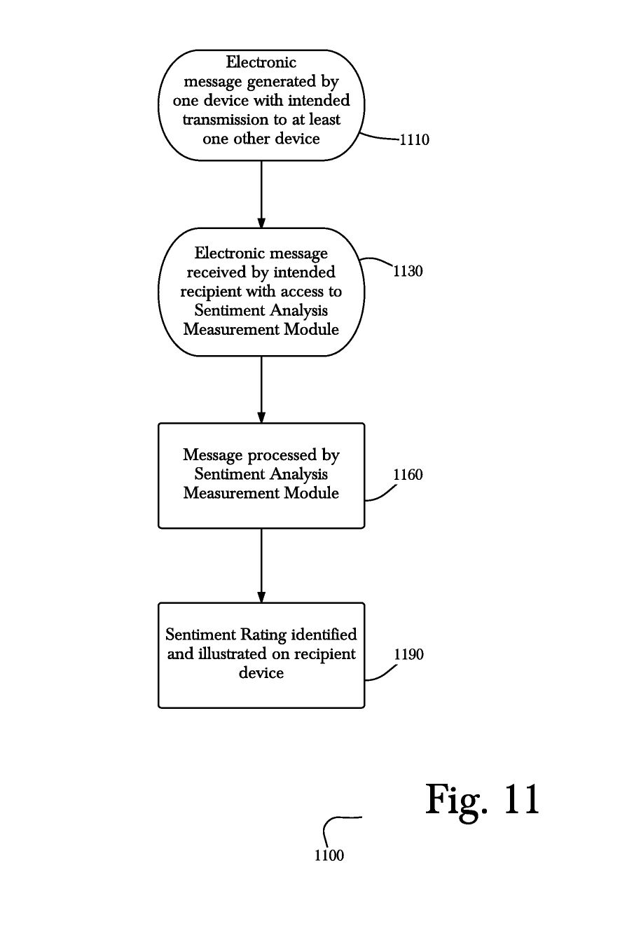

FIG. 11 is a flow diagram illustrating an exemplary method 1100 for collecting a message transmission to process and assign a sentiment rating by using a sentiment analysis measurement module, according to a preferred embodiment of the invention. Simplistically, whether the mode of electronic message transmission is via SMTP for electronic mail or similar such protocol or derivative, such as LMTP, or in case of instant messaging (IM) by way of chat or text messaging via a client-server architecture, an electronic message, be it email, IM, SMS, or other similar such message containing characters, is ultimately generated by one device with an intended transmission and delivery to at least one other device 1110. This first step may comprise several intermediate steps within which may be specific to the mode of delivery, transmission framework, and type of transmission. Within method step 1110, other sub-steps may occur, however irrelevant as a message need only be received by an intended recipient with access to sentiment analysis measurement module, 1130 in a known and designed way, such that system 900/1000 as preferred embodiments of the invention may process 1160 it and identify and illustrate a sentiment rating 1190 on an original recipient device 920A/B/C/D/1020A/B/C/D. The sentiment analysis measurement module 901 or system 900/1000 may be configured to receive and push messages, or collect and relay messages, or even access and return messages or any combination necessary to communicate with a targeted recipient device, such that sentiment may be evaluated and assigned as intended.

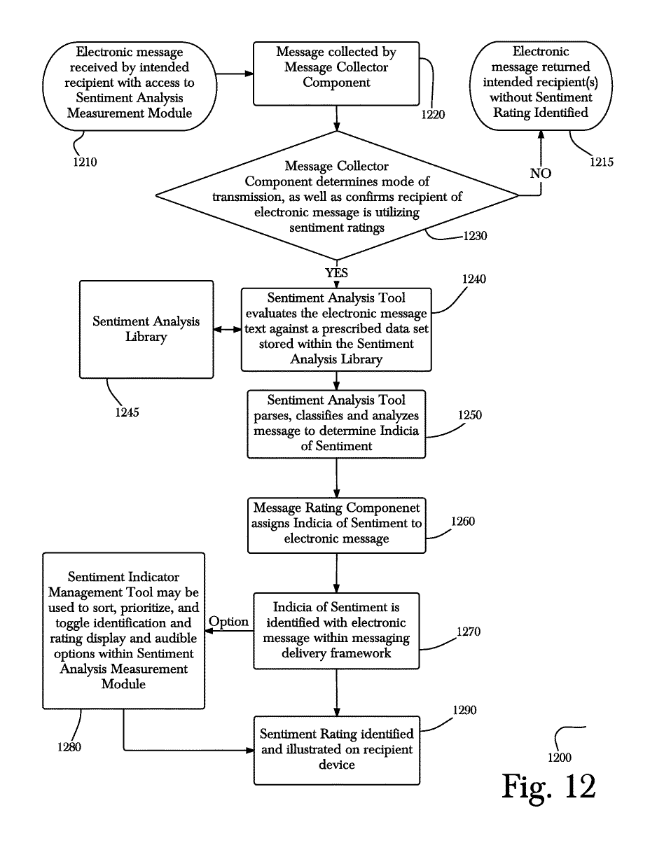

FIG. 12 is a flow diagram illustrating an exemplary method 1200 for measuring and assigning sentiment to an electronically transmitted message by using a sentiment analysis measurement module 900/1000, according to a preferred embodiment of the invention. As depicted in FIG. 11, an electronic message having been received by an intended recipient with access to a sentiment analysis measurement module 1210 is collected by a message collector component 1220 which determines which mode of transmission is intended, then confirms recipient of electronic message is utilizing sentiment ratings 1230 before pushing the message to the sentiment analysis tool 970/1070. If the use of sentiment ratings is not allowed, the original message may be returned to intended recipient(s) 1215 without a sentiment rating identified. If at least one recipient device has sentiment ratings enabled, a sentiment analysis tool evaluates the electronic message text against a prescribed data set 1240 stored in a sentiment analysis library 1245 of key words and phrases, seeking matches and probable matches considering context, inflection, syntax, and grammar of the message being evaluated. The sentiment analysis tool executes an extensive set of algorithms in order to parse, classify and analyze 1250 the message to determine indicia of sentiment, which may be depicted as an integer, being positive representing a positive indicator, being close to zero representing a neutral indicator, and being negative representing a negative indicator. Indicia of sentiment is not necessarily visible within the sentimental rating of a message, but is necessary to identify a selected mode of indication that remains constant and stable in comparison to other rating actions performed. For example, this may equate to a negative integer being represented by a negative identifier, such as a red hue, an angry digitized face, or an image of a thumbs down. Indicia of sentiment, visible or not, is the basic premise for equating sentiment to the message, and the rating scale for sentiment is a function of the indicia of sentiment. A message rating component checks the preferred settings of the recipient device and accordingly assigns the indicia of sentiment to the electronic message 1260 in the desired and programmed format. Indicia of sentiment is identified by the sentiment analysis tool 970/1070 and then assigned by a message rating component 980/1080. The indicia of sentiment may be identified with the electronic message within the messaging delivery framework 1270 before having a sentiment rating identified and illustrated on recipient device 1290. For example, one device may opt for a red color to identify a negatively rated message, whilst a different device may opt for a red color to identify a positively rated message. Whilst indicia of sentiment may be assigned preferentially by use of the sentiment indicator management tool 990/1090, the output from the sentiment analysis tool 970/1070 remains stable to a known scale and associated equation, thus the input from the sentiment analysis tool 970/1070 to the message rating component 980/1080 is also stable and constant, whilst the output of the message rating component 980/1080 may be altered and displayed preferentially, as per settings managed from within the sentiment indicator management tool 990/1090. The sentiment indicator management tool may be used to sort, prioritize, and toggle identification ratings and audible options within the sentiment analysis measurement module 1280, such that a receiving device receives represented indicia of sentiment according to desired preferences, as in the case above, a red hued message to depict positive sentiment in one scenario, or negative sentiment in the other. It is also entirely possible that a red-colored hue could be set to depict a neutral rating, should such a setting be desired to be illustrated on a recipient's device. The choice of color is merely exemplary, and sentiment rating identification is not limited. Sentiment ratings may be attached to the message, displayed in an adjacent field within the message summary page within the delivery framework, or may be embedded within the message itself, forming associative properties with the message. Indicia may be depicted as numbers, integers, colors, visual images or audibly. Furthermore, visual images as indicators may be depicted as artistic renditions of facial expressions, cartoon replications of flora, fauna, natural elements, or virtually any recognizable representation of emotion or sentiment known to the art. Options to upload preferred images or audio files may be managed within the sentiment indicator management tool, and may be shared or kept specific for use on a specified device or set of devices.

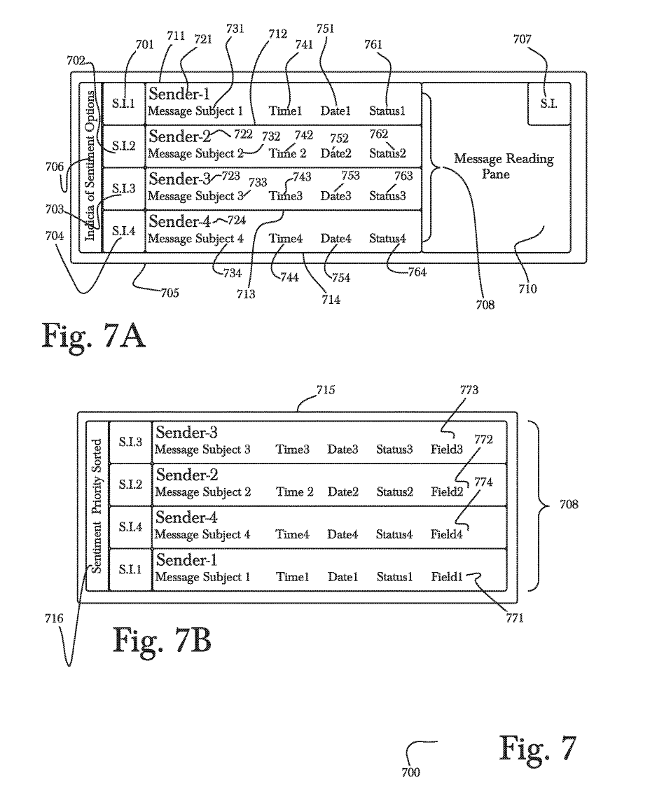

FIG. 7 is a conceptual illustration 700, containing FIG. 7A and FIG. 7B, with each modeling an exemplary sentiment analysis measurement module depicting indicia of sentiment displayed within a generalized messaging system such as, for example, electronic mail, according to a preferred embodiment of the invention. In FIG. 7A, a plurality of fields are labeled specifically to replicate a simple messaging application 705 that may be used on a device, such as, by example, 120A/B/C/D. A messaging application 705 is represented in simplistic form, such that indicia of sentiment (S.I.) 701/702/703/704 may be identified or envisioned as being attached or embedded with an associated message 711/712/713/714 within a stack 708 showing four messages. Each message 711/712/713/714 is summarized and depicted on a home screen within application 705, with certain typical fields identified, such as “Sender” 721/722/723/724; “Message Subject” 731/732/733/734; “Time” 741/742/743/744; “Date” 751/752/753/754; and “Status” 761/762/763/764. A message reading pane 710 may be present, but is illustrated preferentially, and should not be construed as being a requirement of the invention. As in the case of FIG. 7A, the message reading pane 710 is illustrated such that associated indicia of sentiment 707 may be identified. Indicia of sentiment 701, 702, 703, 704, and 707 are depicted in specific locations, however, actual locations of the S.I. may be altered as preferred and managed within the Sentiment Indicator Management

Tool 190/290/390 by selecting the Indicia of Sentiment Options button 706. Again, location of said button is exemplary and for illustration purposes, only. Furthermore, the S.I. 701/702/703/704/707 is not limited to being represented as only an integer or an image, but rather may be depicted as a colored hue or even as a combination of an integer, image, color, and/or even an audible alert.

FIG. 7B depicts another possible interface 715 for identifying indicia of sentiment 701/702/703/704 respective to each associated message 711/712/713/714 illustrated in FIG. 7A. The purpose of FIG. B is to illustrate one possible configuration to sort messages, as opted by a preferred setting within the indicia of sentiment options tab 706. In this example, indicia of sentiment 701/702/703/704 are rearranged in stack 708 along with their associated messages 711/712/713/714 and fields. According to a preferred embodiment of the invention, the indicia of sentiment have been sorted and prioritized with a “Sentiment Priority Sorted” tab 716, highlighted to illustrate sorting of messages 711/712/713/714 has occurred, according to a predetermined rating, with a high priority being placed on “Message-3” 713, followed by a lesser valued rating beneath it, “Message-2” 712, followed by a lesser valued rated message, “Message-4” 714, placing “Message-1” 711 at the bottom of stack 708. Respective fields 773/772/774/771 are illustrated to identify a plurality of viewing options and filed labels for each message 711/712/713/714, and that fields 771/772/773/774 may also represent additional indicia of sentiment associated with each message 711/712/713/714. The sentiment priority sorted tab 716 is one example of text that may occupy the field; other text strings may be presented in this field, as dictated by settings opted in the sentiment indicator management tool, 190/290/390/990/1090. In both illustrations, a preferred embodiment of the invention is illustrated to depict a plurality of options and fields to select and toggle, but with a common factor of the associated indicia of sentiment 701/702/703/704 identified with each respective message 711/712/713/714. The identified indicia of sentiment 701/702/703/704/707 benefit over prior art as they provide a preferred sorting option and identifiers within a messaging framework such that messages may be quickly sorted, identified, read, realized and processed by the recipient device 120A/B/C/D, according to the options selected by said recipient device.

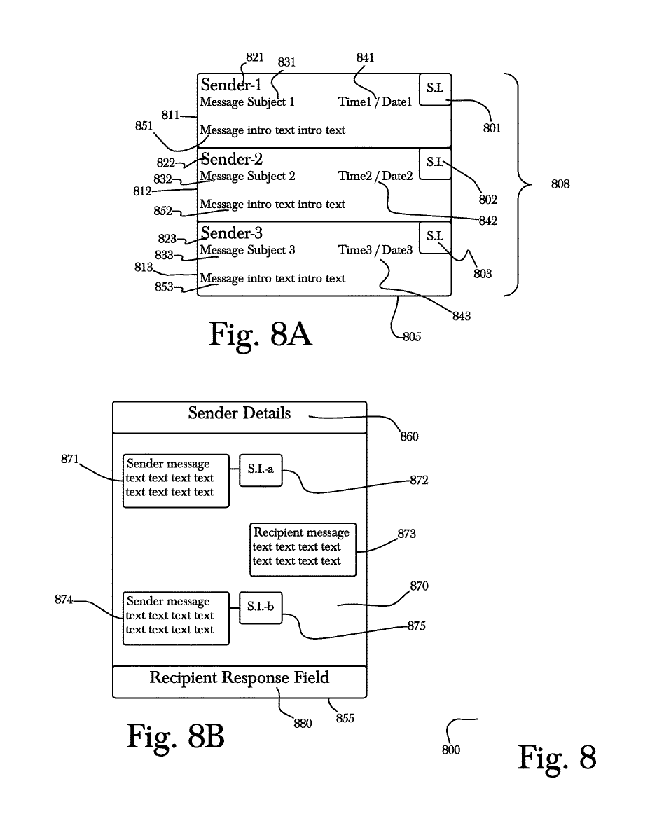

Accordingly, FIG. 8 is another conceptual illustration 800 containing FIG. 8A and FIG. 8B, modeling an exemplary indicia of sentiment displayed within a messaging system such as, for example, instant messaging, according to another preferred embodiment of the invention. In FIG. 8A, a plurality of fields are labeled specifically to replicate a simple messaging application 805 that may be used on a device, such as, by example, 120A/B/C/D. A messaging application 805 is represented in simplistic form, such that indicia of sentiment (S.I.) 801/802/803 may be identified or envisioned as being attached or embedded with an associated message 811/812/813 within a stack 808 showing three messages. Each message 811/812/813 is summarized and depicted on a home screen within application 805, with certain typical fields identified, such as “Sender” 821/822/823; “Message Subject” 831/832/833; “Time/Date” 841/842/843; and a message body summarized to introductory text “Message into text intro text” 851/852/853. Indicia of sentiment 801/802/803 are depicted in specific locations, however, actual locations of the indicia of sentiment may be altered as preferred and managed within the Sentiment Indicator Management Tool 190/290/390. Furthermore, the S.I. 801/802/803 is not limited to being represented as only an integer or an image, but rather may be depicted as a colored hue or even as a combination of an integer, image, color, and/or even an audible alert. FIG. 8B models a detailed conversation between at least one sender and associated recipient, as summarized as a message 811/812/813 in FIG. 8A. Within FIG. 8B, the message 811/812/813 is depicted on a home screen within application 855, with certain typical fields identified, such as “Sender Details” 860; “Recipient Response Field” 880, in which characters to include text and other characters may be typed; and

“Conversation” 870 depicting messages 871/873/874 being exchanged. As sentiment analysis is measured and assigned to an incoming message on a recipient's device, indicia of sentiment 872 and 875 are shown associated with “Sender Message” 871 and 874, respectively. Conversely, the sender message 871/874 may appear with no indicia of sentiment on a sender's device, as the role of sender and recipient devices are exchanged. But in this reversed case, the recipient message 873 may appear with sentiment assigned, as it is viewed by the respective sender's-now-recipient device, and as such, may be tailored to display and identify sentiment according to the respective preferences assigned. Hence, conceptual illustration 800 depicts benefits over prior art, as an instant messaging delivery framework 805/855 shows a way to measure and assign sentiment as indicia of sentiment 801/802/803 which may be identified and presented at time of delivery of the electronic message 811/812/813 or embedded within the electronic message 871/874.

Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

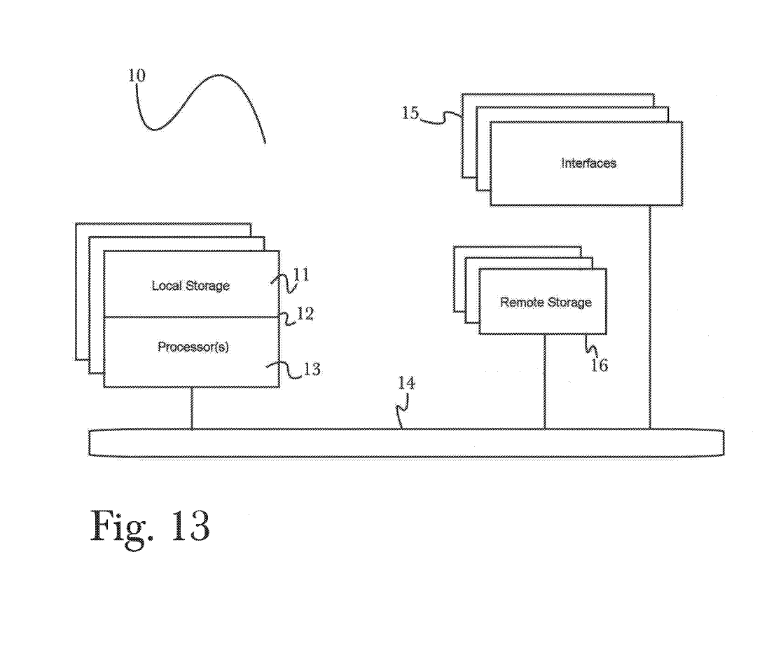

Referring now to FIG. 13, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 13 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

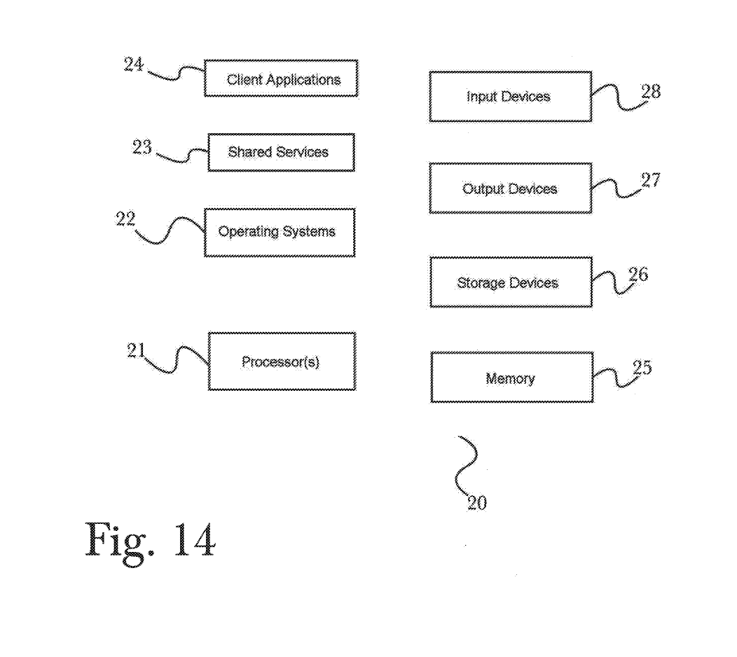

In some embodiments, systems according to the present invention may be implemented on a standalone computing system. Referring now to FIG. 14, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of MICROSOFT WINDOWS™ operating system, APPLE OSX™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 13). Examples of storage devices 26 include flash memory, magnetic hard drive, CD-ROM, and/or the like.

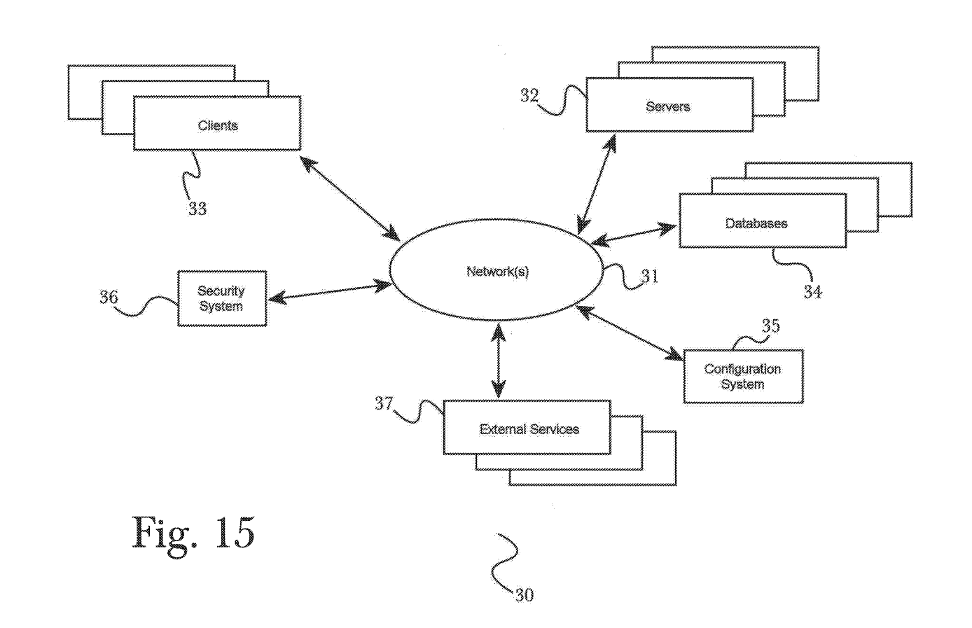

In some embodiments, systems of the present invention may be implemented on a distributed computing network, such as one having any number of clients and/or servers. Referring now to FIG. 15, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 14. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

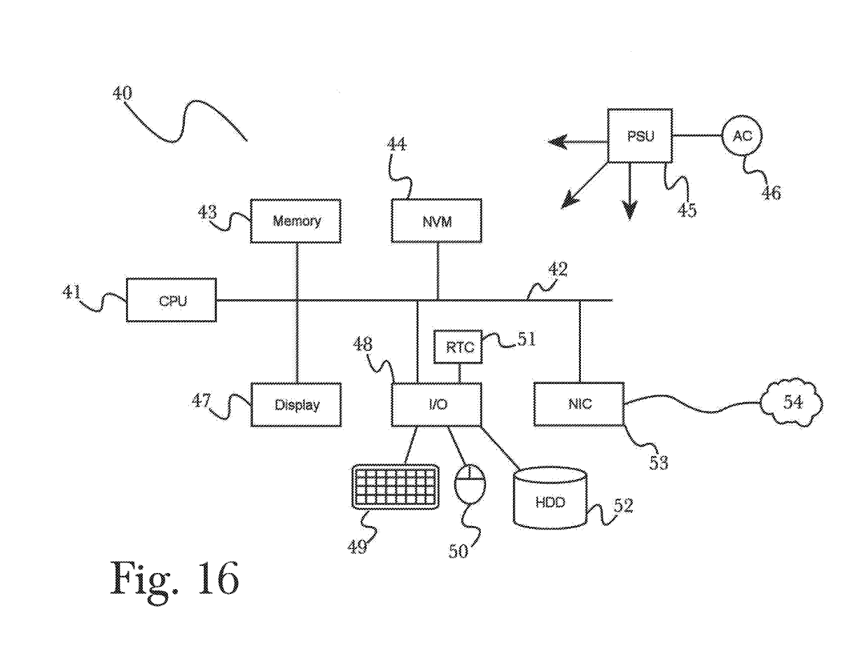

FIG. 16 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

The skilled person will be aware of a range of possible modifications of the various embodiments described above. Accordingly, the present invention is defined by the claims and their equivalents.

What is claimed is:

1. A system for measuring and assigning sentiment to an electronically transmitted message, comprising:
a sentiment analysis measurement module comprising at least a plurality of programming instructions stored in a memory and operating on a processor of a network-connected computing device and configured to:
(a) utilize a message collector component as an interface between an incoming messaging service and a recipient device through which an electronic message will be received;
(b) evaluate the incoming electronic message against a prescribed data set contained within a sentiment analysis database;
(c) communicate with a sentiment analysis tool which executes an extensive set of algorithms to parse, classify and analyze the message such that indicia of sentiment is assigned;
(d) task a message rating component to assign the indicia of sentiment to the message; and
(e) utilize a sentiment indicator management tool to apply a plurality of rules to sort, assign priority, or toggle options for a preferred mode of identification for the indicia of sentiment.

2. The system of claim 1, further comprising a messaging relay component, configured to measure and assign indicia of sentiment which is identified and presented at the same time of delivery of the electronic message or embedded within the electronic message.

3. The system of claim 1, wherein the indicia of sentiment of the electronic message is drawn from a set comprising an audible alert, an integer, a color, a pictorial representation of a facial expression, a pictorial representation of a gesture, or a combination of these indicia.

4. The system of claim 1, wherein the sentiment analysis measurement module is located on a central server, which processes the indicia of sentiment with the message.

5. The system of claim 1, wherein the sentiment analysis measurement module is located on a device, which processes the indicia of sentiment with the message.

6. The system of claim 2, wherein the indicia of sentiment of the electronic message is drawn from a set comprising an audible alert, an integer, a color, a pictorial representation of a facial expression, a pictorial representation of a gesture, or a combination of these indicia.

7. The system of claim 2, wherein the sentiment analysis measurement module is located on a central server connected to at least one network connected device, which process the indicia of sentiment along with the message.

8. The system of claim 3, wherein the audible alert varies in volume.

9. The system of claim 3, wherein the audible alert varies in tone.

10. The system of claim 3, wherein the audible alert produces a plurality of oscillations, causing the computing device to vibrate.

11. The system of claim 6, wherein the audible alert varies in volume.

12. The system of claim 6, wherein the audible alert varies in tone.

13. The system of claim 6, wherein the audible alert produces a plurality of oscillations, causing the computing device to vibrate.

14. A method for measuring and assigning sentiment to an electronically transmitted message by using a sentiment analysis measurement module, the method comprising the steps of:
(a) receiving and collecting electronic messages, either directly or as an appended add-on to another messaging service via a message collector component;
(b) utilizing the message collector component as an interface between an incoming messaging service and a recipient device through which an electronic message will be received;
(c) evaluating the incoming electronic message against a prescribed data set contained within a sentiment analysis database;
(d) communicating with a sentiment analysis tool which executes an extensive set of algorithms to parse, classify and analyze the message such that indicia of sentiment is assigned;
(e) tasking a message rating component to assign the indicia of sentiment to the message; and
(f) utilizing a sentiment indicator management tool to apply a plurality of rules to sort, assign priority, or toggle options for a preferred mode of identification for the indicia of sentiment.

15. A method for assigning and displaying sentiment for an electronically transmitted message by using a sentiment analysis measurement module, the method comprising the steps of:
(a) receiving and collecting electronic messages, either directly or as an appended add-on to another messaging service via a message collector component;
(b) utilizing the message collector component as an interface between an messaging delivery service and a recipient device through which an electronic message will be received;
(c) tasking a message relay component to dispatch the electronic message to a preferred third party sentiment analysis tool which will evaluate and assign a sentiment rating;
(d) tasking a message rating component to assign the indicia of sentiment to the message based on the sentiment rating received; and
(e) utilizing a sentiment indicator management tool to apply a plurality of rules to sort, assign priority, or toggle options for a preferred mode of identification for the indicia of sentiment.

16. A method for assigning and displaying sentiment for an electronically transmitted message by using a sentiment analysis measurement module, the method comprising the steps of:
(a) utilizing a message collector component as an interface between a recipient device through which an electronic message has been received and the sentiment analysis measurement module located on the recipient device;
(b) collecting electronic messages, either directly or as an appended add-on to another messaging service via a message collector component;
(c) evaluating the received electronic message against a prescribed data set contained within a sentiment analysis library;
(d) communicating with a sentiment analysis tool which executes an extensive set of algorithms to parse, classify and analyze the message such that indicia of sentiment is assigned;
(e) tasking a message rating component to assign the indicia of sentiment to the message; and
(f) utilizing a sentiment indicator management tool to apply a plurality of rules to sort, assign priority, or toggle options for a preferred mode of identification for the indicia of sentiment.
